(19) United States
(12) Patent Application Publication
(10) Pub. No.: US 2004/0261011 A1
(43) Pub. Date: Dec. 23, 2004

(54) Patent infringement notification site

(75) Inventors: Bruce Edward Stuckman, Austin, TX (US); Sai Tunuguntla, Round Rock, TX (US)

Correspondence Address: TOLER & LARSON & ABEL L.L.P., 5000 PLAZA ON THE LAKE STE 265, AUSTIN, TX, 78746, US

(73) Assignee: SBC, Inc.

(21) Appl. No.: 10/602,010

(22) Filed: Jun. 23, 2003

(51) Int. Cl. G06F 15/00

(52) U.S. Cl. 715/507

(57) ABSTRACT

A computer site posts an electronic form which displays criteria for infringement of a particular patent. The electronic form accepts first user input to identify an infringement target and second user input to describe how the infringement target meets the criteria.

### FIELD OF THE INVENTION

The present disclosure relates to patent infringement notification methods and systems.

### DESCRIPTION OF THE RELATED ART

Currently, patent holders perform a manually-intensive research process to identify infringers of their patents. To assist in this process, U.S. patent application Publication No. 2002/0165818 to Meade discloses an infringement reporting clearinghouse. The clearinghouse accepts reports of patent infringement by the public, and presents such reports to interested parties such as patent holders. The reports may be submitted and received via traditional mail, other shipping couriers, e-mail, telephone, or a Web page. Infringement reporters receive incentives such as monetary rewards for their reports. Further, the identity of the infringement reporters is protected from the interested parties.

Bountyquest.com operates in another way to help a target of an infringement lawsuit find prior art to defend the lawsuit. Thus, bountyquest.com solves a different problem than that being addressed herein.

### BRIEF DESCRIPTION OF THE DRAWINGS

The present invention is pointed out with particularity in the appended claims. However, other features are described in the following detailed description in conjunction with the accompanying drawing in which:

FIG. 1 is a flow chart of an embodiment of a method of patent infringement notification;

FIG. 2 is a block diagram of an embodiment of a system for patent infringement notification;

FIG. 3 is an illustration of an embodiment of an electronic form to make a patent infringement notification submission; and

FIG. 4 is an illustration of an example of a user-completed electronic form.

### DETAILED DESCRIPTION OF THE DRAWINGS

Embodiments of the present invention provide a Web site or an alternative electronic site that provides a patent infringement notification service. Patent holders, such as companies and/or individuals, can advertise their granted patents on the site in order to detect patent infringers. For each advertised patent, the site posts an electronic form which displays infringement criteria and accepts user input to describe how an infringement target meets the criteria.

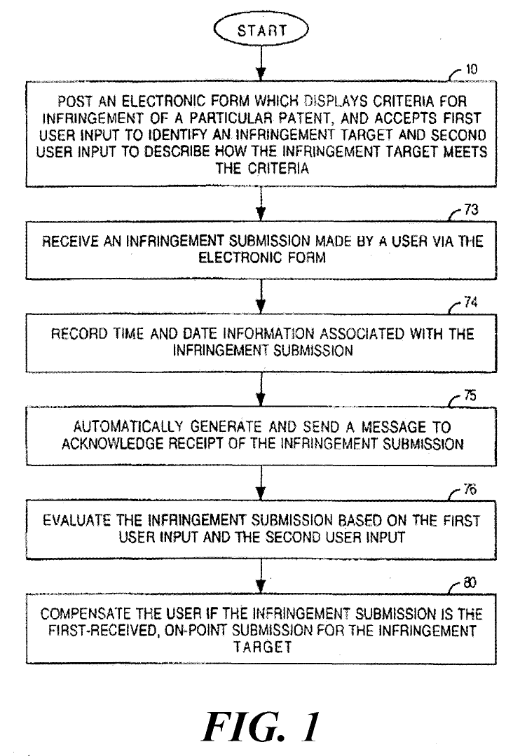

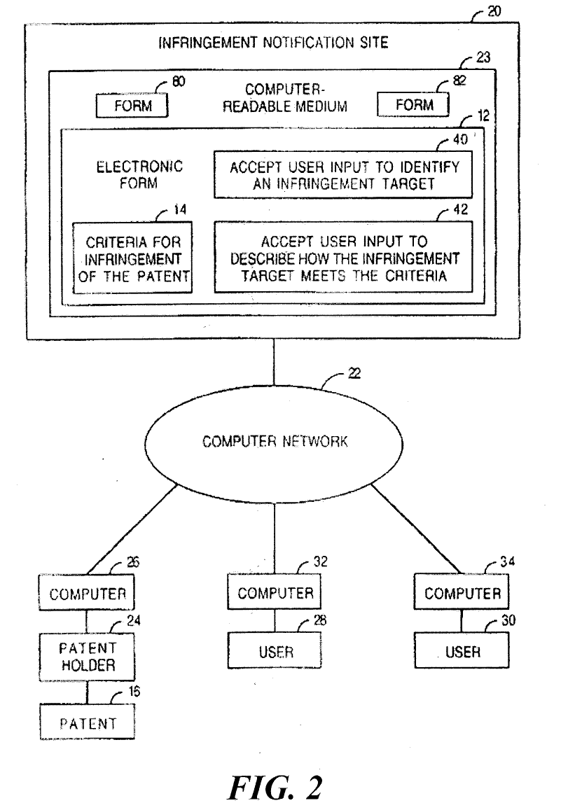

Embodiments of the present invention are described with reference to FIG. 1, which is a flow chart of an embodiment of a method of patent infringement notification, and FIG. 2, which is a block diagram of an embodiment of a system for patent infringement notification.

As indicated by block 10, the method comprises posting an electronic form 12 which displays criteria 14 for infringement of a particular patent 16. Preferably, the criteria 14 comprises one or more claim limitations in a claim in the patent 16. As used herein, the term “claim limitation” should be broadly construed to include any portion of a claim, including its preamble and its body. Thus, a claim limitation can include a recitation of a claim element, cooperation between claim elements, or other limiting language. Examples of claim elements include, but are not limited to, physical elements, acts, steps, matter, computer program code to perform a step or act, and means for performing functions. Examples of cooperation between claim elements include, but are not limited to, structural cooperation, physical cooperation and functional cooperation. The claim may be an independent claim, or a dependent claim. For a dependent claim, the criteria 14 also includes criteria in its base independent claim and any intervening dependent claims. Optionally, the criteria 14 may be translated, either by a human translator or an automatic translator system, from a first language of the patent 16 to a second language. The criteria 14 can be displayed in the second language either in addition to or as an alternative to the first language. In general, the criteria 14 can be displayed in any number of languages to broaden the scope of individuals who can detect patent infringers.

The electronic form 12 is posted by a computer site 20 accessible via a computer network 22. Examples of the computer network 22 include, but are not limited to, an Internet, an intranet, an extranet, a local area network, and a wide area network. In one embodiment, the computer site 20 comprises a Web site which provides the electronic form 12 in the form of a Web page or other output viewable by a browser program.

The computer site 20 stores the electronic form 12 in a computer-readable medium 23. Examples of the computer-readable medium 23 include, but are not limited to, a magnetic medium such as a hard disk, an optical medium such as an optical disk, or an electronic medium such as an electronic memory.

The electronic form 12 may be posted in response to a request to list the patent 16 from its patent holder 24. The patent holder 24 is one or more companies, one or more individuals, or a combination thereof, who owns the patent 16. The patent holder 24 may make the request using a computer 26. The request is communicated from the computer 26 to the computer site 20 via the computer network 22.

The electronic form 12 is viewable by a plurality of users. For purposes of illustration and example, two users 28 and 30 are shown in FIG. 2. The users 28 and 30 view the electronic form 12 using computers 32 and 34, respectively. The computers 32 and 34 receive the electronic form 12 from the computer site 20 via the computer network 22. The computers 32 may be equipped with browser software, such as Microsoft's Internet Explorer or Netscape's Navigator, to display the electronic form 12 for view by the users 28 and 30, respectively.

Access to the electronic form 12 may be either limited or unlimited. The access may be limited by the scope of the computer network 22 and/or limited by the computer site 20. For example, the computer network 22 may comprise an intranet whose scope limits access to the electronic form 12 to employees and other individuals associated with a particular company. As another example, the computer site 20 may limit access to the electronic form 12 via the Internet or an extranet to qualified users.

The users view the electronic form 12 to determine if they can provide details of infringement. The electronic form 12 accepts first user input 40 to identify an infringement target, and second user input 42 to describe how the infringement target meets the criteria 14. The first user input 40 may comprise one or more of a product name, a trademark, a service name, a service mark, and a company name to identify the infringement target. The second user input 42 comprises natural language textual input and/or graphical input, entered and/or drawn by a user using his/her computer, to describe a product or service.

The electronic form 12 lists any infringement targets that already have been identified, either by other users or by the patent holder 24, for the patent 16. These pre-existing targets do not qualify for awards to subsequent users who identify the same target.

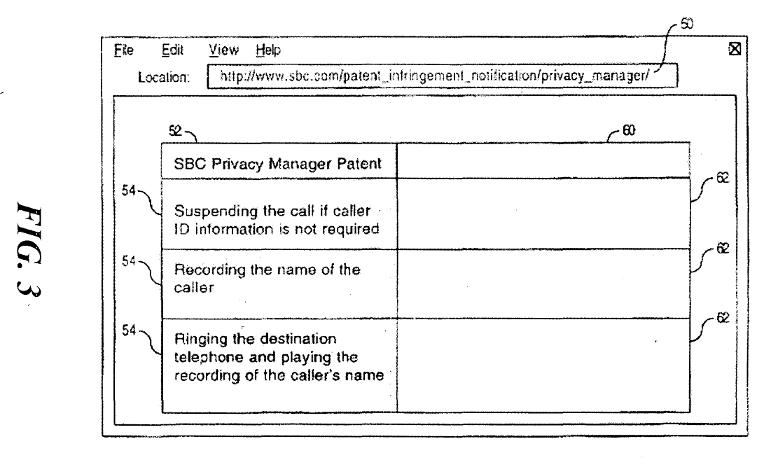

FIG. 3 is an illustration of an embodiment of the electronic form. The electronic form comprises a Web form which is processed by browser software installed in a user's computer for display to the user. The electronic form is accessible at an address 50 associated with the computer site 20.

The electronic form comprises a display portion 52 to identify the patent 16. The electronic form also has a plurality of display portions 54 each to display a respective one of the criteria 14. For purposes of illustration and example, the patent 16 has a claim that is divided into three criteria, each of the three criteria being a claim limitation, and each claim limitation being assigned to a respective one of the display portions 54.

The electronic form has an input box 60 to accept the first user input to identify an infringement target. The electronic form also has a plurality of input boxes 62 to accept the second user input to describe how the infringement target meets the criteria 14 in the display portions 54. Each of the input boxes 62 is associated with a respective one of the criteria 14, and is adjacent to a respective one of the display portions 54 to receive a portion of the second user input which describes how the infringement target meets the respective one of the criteria 14. In one embodiment, the display portions 54 are arranged in a first column of the electronic form, and the input boxes 62 are arranged in a second column of the electronic form. Each of the input boxes 60 and 62 is to receive natural language textual input from a user.

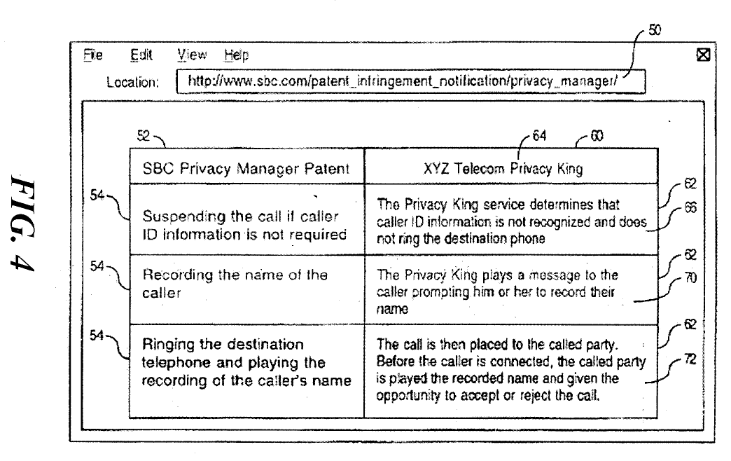

FIG. 4 is an illustration of an example of a user-completed electronic form. The user identifies the infringement target by entering text 64 comprising a company name “XYZ Telecom” and a service name “Privacy King” into the input box 60. The user describes how the infringement target meets the criteria 14 in each of the display portions 54 by entering text 66, 70 and 72 into the input boxes 62. Thereafter, the user submits the completed electronic form to the computer site 20.

Returning to FIG. 1, the method comprises receiving an infringement submission made by a user via the electronic form 12, as indicated by block 73. The infringement submission is received by the computer site 20 via the computer network 22.

As indicated by block 74, information indicating a time and date at which the infringement submission was received and/or made is recorded by the computer site 20. The time and date information can be used to determine which submission is first in time if multiple submissions identifying the same infringement target are received for the same patent. The aforementioned multiple submissions are referred to herein as “duplicate submissions”.

As indicated by block 75, an optional act of automatically generating and sending an acknowledgment message is performed. The acknowledgment message, which acknowledges receipt of the infringement submission, is sent from the computer site 20 to the user. The acknowledgment message can comprise a time and date stamp based on the time and date information associated with the infringement submission. In one embodiment, the acknowledgment message comprises an e-mail message sent from the computer site 20 to the user.

As indicated by block 76, an act of evaluating the infringement submission is performed based on the first user input and the second user input. The act of evaluating is performed by one or more patent attorneys or other intellectual property personnel to determine if the infringement submission is the first-received, on-point submission for the infringement target with respect to the patent 16. In determining whether a duplicate submission is received, the infringement target for a later submission is compared with earlier submissions to determine if the same company and/or product or service is identified. In one embodiment, if the later submission identifies the same company but a different product or service associated with the company identified in an earlier submission, the later submission is not considered to be a duplicate of the earlier submission.

As indicated by block 80, the method comprises compensating the user if the infringement submission is the first-received, on-point submission for the infringement target with respect to the patent 16. The user may be provided either a fixed fee, a fee commensurate with compensation from a deal with the infringement target, or a combination thereof. Regardless of the compensation, the act of compensating the user may be conditioned on the deal being finalized with the infringement target. An example of the deal is the infringement target agreeing to pay a royalty.

The above acts may be repeated for other patents to produce other electronic forms, such as electronic forms 80 and 82 in FIG. 2, provided by the computer site 20. Two examples illustrating practical applications of the patent infringement notification site are described below.

### EXAMPLE 1

Using the herein-disclosed electronic form and method, a company can establish an intranet site to post its patents. For each patent that is posted, the patent claim elements are identified. These claim elements correspond to the criteria that is target company must meet to infringe the patent. Target companies that already have been identified for the patent are also listed. Employees of the company are invited to search for target infringers of patents they find interesting. If an employee finds a target infringer, he/she submits a Web form that indicates how he/she believes the target infringes the patent.

The submission is reviewed by an intellectual property and/or legal department of the company. If the target information is the first-submitted, on-point submission on the target, the employee gets a finder award (e.g. $100, $500 or another amount) from the company. The award could be conditioned on actually doing a deal with the target company. The finder award could be a fixed fee or a percentage of the revenue collected from the deal.

### EXAMPLE 2

Using the herein-disclosed electronic form and method, a company can establish a Web site to post patents on the Internet. The Web site posts patents from multiple companies in exchange for a fee. Examples of the fee include, but are not limited to, a listing fee, a percentage of a deal, a found target fee, or any combination thereof. Any Internet user can use the service to collect a fee for identifying an infringement target.

As evident by the above examples, a company can secure leads on potential infringers by advertising patent claims that have been potentially infringed on a Web site accesible to either an employee base or the general public. With a suitable reward mechanism, the service motivates qualified people from all around the world to participate in identifying infringers. A suitable trust mechanism, e.g. like Ebay.com, Epinions.com, or Amazon.com, can be established to discourage and/or filter out weak leads and prank leads.

Embodiments of the present invention are well-suited for identifying infringers in one or more particular countries of the patent holder's choice. The patent holder can access the talents and skills of people from all over the world to join forces for patent infringement identification purposes. In a global environment where companies are increasingly protective of their intellectual property in multiple countries, such a service provides a cost-effective, timely, scaleable and manageable system.

It will be apparent to those skilled in the art that the disclosed embodiments may be modified in numerous ways and may assume many embodiments other than the preferred forms specifically set out and described herein.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
posting an electronic form which displays criteria for infringement of a particular patent and accepts first user input to identify an infringement target and second user input to describe how the infringement target meets the criteria.

2. The method of claim I wherein the electronic form comprises a plurality of input boxes to accept the second user input.

3. The method of claim 2 wherein each of the plurality input boxes is associated with a respective one of the criteria.

4. The method of claim 2 wherein the electronic form has a plurality of display portions each to display a respective one of the criteria, and wherein each of the plurality of input boxes is positioned adjacent to one of the plurality of display portions to receive a portion of the second user input which describes how the infringement target meets the respective one of the criteria.

5. The method of claim 4 wherein the display portions are arranged in a first column of the electronic form, and wherein the input boxes are arranged in a second column of the electronic form.

6. The method of claim 4 wherein the criteria comprises a plurality of claim limitations, and wherein each of the claim limitations is associated with one of the plurality of display portions is associated with one of the plurality of input boxes.

7. The method of claim 2 wherein the electronic form comprises an input box to accept the first user input.

8. The method of claim 2 wherein each of the plurality of input boxes is to receive natural language textual input.

9. The method of claim I wherein the electronic form comprises a Web form.

10. The method of claim 1 wherein the infringement target is identified by a product name in the first user input.

11. The method of claim I wherein the infringement target is identified by a company name in the first user input.

12. The method of claim I further comprising:
receiving an infringement submission made by a user via the electronic form; and
evaluating the infringement submission based on the first user input and the second user input.

13. The method of claim 12 wherein said evaluating is performed by a patent attorney.

14. The method of claim 12 further comprising:
compensating the user if the infringement submission is evaluated to be a first-received on-point submission for the infringement target.

15. The method of claim 14 wherein said compensating the user is conditioned on a deal with the infringement target.

16. The method of claim 14 wherein said compensating the user comprises providing the user a fixed fee.

17. The method of claim 14 wherein said compensating the user comprises providing the user a fee commensurate with compensation from a deal with the infringement target.

18. The method of claim 12 further comprising:
recording a date and a time associated with the infringement submission.

19. The method of claim 18 further comprising:
sending, to the user, a message to acknowledge receipt of the infringement submission, the message indicating the date and the time associated with the infringement submission.

20. The method of claim I wherein the electronic form is posted on an intranet.

21. The method of claim I wherein the electronic form is posted on the Internet.

22. The method of claim I wherein the second user input comprises graphical input.

23. The method of claim 1 further comprising:
translating the criteria from a first language to a second language;
wherein the criteria is displayed in the second language.

24. An article comprising:
a computer-readable medium having stored thereon an electronic form to display criteria for infringement of a particular patent and to accept first user input to identify an infringement target and second user input to describe how the infringement target meets the criteria.

25. The article of claim 24 wherein the electronic form comprises a plurality of input boxes to accept the second user input.

26. The article of claim 25 wherein each of the plurality of input boxes is associated with a respective one of the criteria.

27. The article of claim 25 wherein the electronic form has a plurality of display portions each to display a respective one of the criteria, and wherein each of the plurality of input boxes is adjacent to one of the plurality of display portions to receive a portion of the second input that describes how the infringement target meets the respective one of the criteria.

28. The article of claim 27 wherein the plurality of display portions are arranged in a first column of the electronic form, and wherein the plurality of input boxes are arranged in a second column of the electronic form.

29. The article of claim 27 wherein the criteria comprises a plurality of claim limitations, and wherein each of the claim limitations has an associated one of the plurality of display portions and an associated one of the plurality of input boxes.

30. The article of claim 25 wherein the electronic form comprises an input box to accept the first user input.

31. The article of claim 25 wherein each of the plurality of input boxes is to receive natural language textual input.

32. The article of claim 24 wherein the electronic form comprises a Web form.

33. The article of claim 24 wherein the second user input comprises graphical input.

34. The article of claim 24 wherein the criteria is translated from a first language to a second language.
